(19) United States
(12) Patent Application Publication
(10) Pub. No.: US 2026/0055337 A1
(43) Pub. Date: Feb. 26, 2026

(54) POWDER DETERGENT

(71) Applicant: Chia-Wei TENG, Taipei City (TW)

(72) Inventor: Chia-Wei TENG, Taipei City (TW)

(21) Appl. No.: 19/213,554

(22) Filed: May 20, 2025

(30) Foreign Application Priority Data
Aug. 20, 2024 (TW) 113131235

(51) Int. Cl. C11D 1/14; C11D 3/12; C11D 3/20; C11D 3/22; C11D 3/33; C11D 3/382; C11D 17/06

(52) U.S. Cl. CPC C11D 1/146; C11D 3/124; C11D 3/2079; C11D 3/222; C11D 3/33; C11D 3/382; C11D 17/06

(57) ABSTRACT

A powder detergent includes sodium C₁₄₋₁₆ olefin sulfonate, sodium coco sulfate, a thickener, a preservative, a chelating agent, and hydrated silica. Based on a total weight of the powder detergent, the sodium C₁₄₋₁₆ olefin sulfonate is in an amount ranging from 45 wt % to 55 wt %, the sodium coco sulfate is in an amount ranging from 25 wt % to 35 wt %, and the thickener is in an amount ranging from 5 wt % to 15 wt %. The sodium C14-16 olefin sulfonate, the sodium coco sulfate, and the thickener are in a total amount of 91.2 wt %.

### CROSS-REFERENCE TO RELATED APPLICATION

This application claims priority to Taiwanese Invention Patent Application No. 113131235, filed on Aug. 20, 2024, the entire disclosure of which is incorporated by reference herein.

### FIELD

The disclosure relates to a detergent, and more particularly to a powder detergent.

### BACKGROUND

Compared to a liquid detergent, a solid detergent not only lowers transportation costs and requires less storage space, but also has a longer shelf life since it contains no water and is thus less likely to breed bacteria and mold. In use, a powder detergent, e.g., a powder dishwashing detergent, only needs to be mixed with water. However, commercially available powder detergents often have disadvantages, such as caking and undesirable dissolution rates in water, which result in relatively long dissolution times and cause inconvenience to users.

### SUMMARY

Therefore, an object of the disclosure is to provide a powder detergent that can alleviate at least one of the drawbacks of the prior art.

According to the disclosure, the powder detergent includes sodium C₁₄₋₁₆ olefin sulfonate, sodium coco sulfate, a thickener, a preservative, a chelating agent, and hydrated silica. Based on a total weight of the powder detergent, the sodium C₁₄₋₁₆ olefin sulfonate is in an amount ranging from 45 wt % to 55 wt %, the sodium coco sulfate is in an amount ranging from 25 wt % to 35 wt %, and the thickener is in an amount ranging from 5 wt % to 15 wt %. The sodium C14-16 olefin sulfonate, the sodium coco sulfate, and the thickener are in a total amount of 91.2 wt %.

### DETAILED DESCRIPTION

An embodiment of a powder detergent according to the present disclosure includes sodium C₁₄₋₁₆ olefin sulfonate, sodium coco sulfate, a thickener, a preservative, a chelating agent, and hydrated silica. Based on a total weight of the powder detergent, the sodium C₁₄₋₁₆ olefin sulfonate is in an amount ranging from 45 wt % to 55 wt %, the sodium coco sulfate is in an amount ranging from 25 wt % to 35 wt %, and the thickener is in an amount ranging from 5 wt % to 15 wt %.

In the embodiment of the powder detergent, the sodium C₁₄₋₁₆ olefin sulfonate and the sodium coco sulfate are used as surfactants. In some embodiments, the thickener includes xanthan gum. In certain embodiments, the thickener is xanthan gum.

The sodium C₁₄₋₁₆ olefin sulfonate in the amount ranging from 45 wt % to 55 wt % allows the powder detergent to have a strong cleaning capability. The sodium coco sulfate in the amount ranging from 25 wt % to 35 wt % makes the powder detergent, when dissolved in water, form rich foam. The thickener in the amount ranging from 5 wt % to 15 wt % allows a detergent solution, obtained by dissolving the power detergent in water, to have proper viscosity.

In some embodiments, based on the total weight of the powder detergent, the sodium C₁₄₋₁₆ olefin sulfonate, the sodium coco sulfate and the thickener are in a total amount of 91.2 wt %. In some embodiments, based on the total weight of the powder detergent, the sodium C₁₄₋₁₆ olefin sulfonate is in the amount of 54.5 wt %, the sodium coco sulfate is in the amount of 31.7 wt %, and the thickener is in the amount of 5 wt %. With such particular amounts, the powder detergent of the embodiment of the present disclosure may have a relatively fast dissolution rate in water, the proper viscosity and the strong cleaning capability.

With the preservative, the powder detergent of this embodiment may have a longer shelf life. In some embodiments, based on the total weight of the powder detergent, the preservative is in an amount ranging from 5 wt % to 10 wt %. In some embodiments, the preservative includes sodium benzoate. In certain embodiments, the preservative is sodium benzoate and is in the amount of 7 wt %.

In some embodiments, based on the total weight of the powder detergent, the chelating agent is in an amount ranging from 0.1 wt % to 2 wt %. In some embodiments, the chelating agent includes tetrasodium glutamate diacetate. In certain embodiments, the chelating agent is tetrasodium glutamate diacetate and is in the amount of 0.8 wt %.

In some embodiments, the hydrated silica may be introduced into the powder detergent such that the detergent solution may have good uniformity, proper viscosity, and a strong cleaning capability. In some embodiments, based on the total weight of the powder detergent, the hydrated silica is in an amount ranging from 0.1 wt % to 2 wt %. In some embodiments, the hydrated silica is in the amount of 0.7 wt %.

In some embodiments, based on the total weight of the powder detergent, the C₁₄₋₁₆ olefin sulfonate is in the amount of 54.5 wt %, the sodium coco sulfate is in the amount of 31.7 wt %, the thickener, e.g., xanthan gum, is in the amount of 5 wt %, the preservative is in the amount of 7 wt %, the chelating agent is in the amount of 0.8 wt %, and the hydrated silica is in the amount of 0.7 wt %.

In some embodiments, the powder detergent further includes an essential oil so that the scent of the powder detergent may be improved. In some embodiments, the essential oil is grapefruit essential oil. In some embodiments, based on the total weight of the powder detergent, the essential oil is in an amount of 0.3 wt %.

In certain embodiments, based on the total weight of the powder detergent, the C₁₄₋₁₆ olefin sulfonate is in the amount of 54.5 wt %, the sodium coco sulfate is in the amount of 31.7 wt %, the thickener is in the amount of 5 wt %, the preservative is in the amount of 7 wt %, the chelating agent is in the amount of 0.8 wt %, the hydrated silica is in the amount of 0.7 wt %, and the essential oil is in the amount of 0.3 wt %.

In some embodiments, the powder detergent is a dishwashing powder. The powder detergent may be used for cleaning tableware and cookware, such as dishes, pots, and cups. Users may simply dissolve an appropriate amount of the powder detergent in water to obtain the detergent solution having the proper viscosity similar to that of regular dishwashing liquid.

The present disclosure will be further described with reference to the following example. However, it should be understood that the following example is merely for illustration purposes and should not be considered as a limitation to the implementation of the present disclosure.

In the example, 54.5 wt % of sodium C₁₄₋₁₆ olefin sulfonate (commercially available from Taiwan NJC Corp.), 31.7 wt % of sodium coco sulfate (commercially available from Stepan Company), 5 wt % of the xanthan gum (commercially available from CP Kelco), 7 wt % of sodium benzoate, 0.8 wt % of tetrasodium glutamate diacetate, 0.7 wt % of hydrated silica, and 0.3 wt % of grapefruit essential oil were homogeneously mixed to obtain a powder detergent.

### Evaluation of Dissolution Rate

Firstly, 20 g of the powder detergent was added into 250 ml of water. An amount of time that it took for the powder detergent to completely dissolve in the water was recorded. A dissolution rate of the powder detergent was calculated according to a formula: an amount of the powder detergent/the amount of time that it took for the powder detergent to completely dissolve in the water. The results are presented in Table 1.

TABLE 1

| | Powder detergent |
|---|---|
| The amount of the powder detergent (g) | 20 |
| The amount of time for the powder | 0.3 |
| detergent to completely dissolve (hour) | |
| The dissolution rate of the powder | 67 |
| detergent (g/hour) | |

In summary, with the combination of the sodium C₁₄₋₁₆ olefin sulfonate, the sodium coco sulfate, the thickener, the preservative, the chelating agent, and the hydrated silica, and with the specific weight percentages of the sodium C₁₄₋₁₆ olefin sulfonate, the sodium coco sulfate, and the thickener, the embodiment of the powder detergent of this disclosure may be effectively dissolved in water without caking, and the detergent solution may have proper viscosity and rich foam. In addition, the powder detergent of this disclosure may have a longer shelf life with good shelf stability, and good resistance against bacterial and mold growth. When the powder detergent of the present disclosure is used for washing tableware and cookware, oil and food residuals left on the tableware and cookware may be effectively removed due to the strong cleaning capability of the powder detergent of this disclosure. Furthermore, the powder detergent is gentle on the skin so that users may have a pleasant experience while washing with the powder detergent. Additionally, the powder detergent of the present disclosure is made of environmentally friendly materials so that the manufacturing, transport and use of the powder detergent may have relatively low environmental impacts.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A powder detergent comprising:
sodium C₁₄₋₁₆ olefin sulfonate;
sodium coco sulfate;
a thickener;
a preservative;
a chelating agent; and
hydrated silica,
wherein based on a total weight of said powder detergent, the sodium C₁₄₋₁₆ olefin sulfonate is in an amount ranging from 45 wt % to 55 wt %, the sodium coco sulfate is in an amount ranging from 25 wt % to 35 wt %, and the thickener is in an amount ranging from 5 wt % to 15 wt %, and the sodium C₁₄₋₁₆ olefin sulfonate, the sodium coco sulfate, and the thickener are in a total amount of 91.2 wt %.

2. The powder detergent as claimed in claim 1, wherein the thickener includes xanthan gum.

3. The powder detergent as claimed in claim 1, wherein the preservative includes sodium benzoate.

4. The powder detergent as claimed in claim 3, wherein based on the total weight of said detergent, the preservative is in an amount ranging from 5 wt % to 10 wt %.

5. The powder detergent as claimed in claim 1, wherein based on the total weight of said powder detergent, the preservative is in an amount ranging from 5 wt % to 10 wt %.

6. The powder detergent as claimed in claim 1, wherein based on the total weight of said powder detergent, the hydrated silica is in an amount ranging from 0.1 wt % to 2 wt %.

7. The powder detergent as claimed in claim 1, wherein the chelating agent includes tetrasodium glutamate diacetate.

8. The powder detergent as claimed in claim 7, wherein based on the total weight of said powder detergent, the chelating agent is in an amount ranging from 0.1 wt % to 2 wt %.

9. The powder detergent as claimed in claim 1, wherein based on the total weight of said powder detergent, the chelating agent is in an amount ranging from 0.1 wt % to 2 wt %.

10. The powder detergent as claimed in claim 1, wherein based on the total weight of said powder detergent, the C₁₄₋₁₆ olefin sulfonate is in the amount of 54.5 wt %, the sodium coco sulfate is in the amount of 31.7 wt %, and the thickener is in the amount of 5 wt %.

11. The powder detergent as claimed in claim 10, wherein the thickener is xanthan gum.

12. The powder detergent as claimed in claim 1, wherein based on the total weight of said powder detergent, the C₁₄₋₁₆ olefin sulfonate is in the amount of 54.5 wt %, the sodium coco sulfate is in the amount of 31.7 wt %, the thickener is in the amount of 5 wt %, the preservative is in an amount of 7 wt %, the chelating agent is in an amount of 0.8 wt %, and the hydrated silica is in an amount of 0.7 wt %.

13. The powder detergent as claimed in claim 12, wherein the thickener is xanthan gum.

14. The powder detergent as claimed in claim 1, further comprising an essential oil.

15. The powder detergent as claimed in claim 1, which is a dishwashing powder.
